(19) United States
(12) Patent Application Publication
(10) Pub. No.: US 2026/0113571 A1
(43) Pub. Date: Apr. 23, 2026

(54) EARPHONES

(71) Applicant: SHENZHEN SHOKZ CO., LTD., Shenzhen (CN)

(72) Inventors: Tao ZHAO, Shenzhen (CN); Haochen LIU, Shenzhen (CN); Peigeng TONG, Shenzhen (CN); Chaojie CUI, Shenzhen (CN); Jiang XU, Shenzhen (CN); Lei ZHONG, Shenzhen (CN)

(73) Assignee: SHENZHEN SHOKZ CO., LTD., Shenzhen (CN)

(21) Appl. No.: 19/424,053

(22) Filed: Dec. 17, 2025

Related U.S. Application Data
(63) Continuation of application No. PCT/CN2024/096715, filed on May 31, 2024.

(51) Int. Cl. H04R 3/00; H04R 1/10; H04R 1/40

(52) U.S. Cl. CPC H04R 3/005; H04R 1/1008; H04R 1/1041; H04R 1/105; H04R 1/1075; H04R 1/406; H04R 2410/01; H04R 2410/07; H04R 2460/11

(57) ABSTRACT

Provided is an earphone. The earphone includes a sound-producing portion, an abutting portion, and an ear hook. The abutting portion includes two first microphones, the two first microphones are configured to collect a first sound respectively. The sound-producing portion includes a second microphone, and the second microphone is configured to collect a second sound. The earphone further includes a detection element and a processing circuit. The detection element is configured to detect a relative positional relationship between the two first microphones in a wearing state. The processing circuit controls one first microphone relatively higher in a gravity direction to be in an operating state and controls other one first microphone relatively lower in the gravity direction to be in a non-operating state according to a detection result of the detection element, and further performs noise reduction processing based on the first sound and the second sound.

### CROSS-REFERENCE TO RELATED APPLICATIONS

This application is a Continuation of International Application No. PCT/CN2024/096715, filed on May 31, 2024, the contents of which are incorporated herein by reference.

### TECHNICAL FIELD

The present disclosure relates to the field of electronic devices, and in particular, to an earphone.

### BACKGROUND

Earphones have been widely used in people's daily lives. They may be used with electronic devices like mobile phones and computers to provide users with sound playback functionality. Ear-clip earphones are a new type of earphone. They are usually small in size and may be clipped onto the wearer's auricle for use. Furthermore, since these ear-clip earphones do not block the ear canal, they not only ensure safety in outdoor scenarios but also offer better wearing comfort compared to in-ear EARphones.

However, the sound pickup effect of current ear-clip earphones is challenging to meet demands.

### SUMMARY

One or more embodiments of the present disclosure provide an earphone. The earphone comprises a sound-producing portion, an abutting portion, and an ear hook. The ear hook connects the sound-producing portion and the abutting portion. In a wearing state, the sound-producing portion and the abutting portion form a clamping state on two sides of an auricle, and the sound-producing portion is located in a cavum conchae. The abutting portion includes two first microphones. The two first microphones are configured to collect a first sound respectively. The sound-producing portion includes a second microphone. The second microphone is configured to collect a second sound. The earphone further comprises a detection element and a processing circuit. The detection element is configured to detect a relative positional relationship between the two first microphones in the wearing state. The processing circuit controls one first microphon of the two first microphones that is relatively higher in a gravity direction to be in an operating state and controls other one first microphon of the two first microphones that is relatively lower in the gravity direction to be in a non-operating state according to a detection result of the detection element, and further performs noise reduction processing based on the first sound collected by the first microphone in the operating state and the second sound collected by the second microphone.

In some embodiments, the ear hook has a symmetry plane arranged along a length direction of the ear hook. The abutting portion further includes a first housing. The first housing is provided with two first sound entry holes. Each of the two first microphones collects the first sound through a corresponding one of the two first sound entry holes. The two first sound entry holes respectively have a sound entry end located on an outer wall surface of the first housing. The sound entry ends of the two first sound entry holes are arranged on two sides of the symmetry plane.

In some embodiments, the sound entry ends of the two first sound entry holes are symmetrically arranged relative to the symmetry plane.

In some embodiments, the first housing includes a main body portion. The main body portion includes a peripheral side wall and two end walls arranged opposite to each other. The peripheral side wall is configured to contact a back side of the auricle. The two first sound entry holes are respectively arranged on the two end walls of the abutting portion.

In some embodiments, the first housing includes a main body portion. The main body portion includes a peripheral side wall and two end walls arranged opposite to each other. The peripheral side wall is configured to contact a back side of the auricle. The two first sound entry holes are both arranged on the peripheral side wall of the abutting portion and are located on a side of the peripheral side wall facing away from the sound-producing portion.

In some embodiments, in a direction perpendicular to the symmetry plane, a shortest straight-line distance between hole edges of the sound entry ends of the two first sound entry holes is greater than or equal to 10 mm.

In some embodiments, a shortest straight-line distance from a hole edge of each of the sound entry ends of the two first sound entry holes to the symmetry plane is greater than or equal to 5 mm.

In some embodiments, the processing circuit is further configured to perform wind noise detection based on at least one of the first sound or the second sound, and when it is detected that a wind noise is greater than or equal to a preset threshold, the processing circuit further controls the other one first microphone of the two first microphones that is relatively lower in the gravity direction to be in the operating state and controls the second microphone to be in the non-operating state.

In some embodiments, the sound-producing portion includes a second housing. The second housing is provided with a second sound entry hole. The second microphone collects the second sound via the second sound entry hole. The second sound entry hole has a sound entry end located on an outer wall surface of the second housing. A shortest straight-line distance between a hole edge of each of the sound entry ends of the two first sound entry holes and a hole edge of the sound entry end of the second sound entry hole is greater than or equal to 15 mm.

In some embodiments, each of the two first sound entry holes has a first axial direction pointing to an outside of the first housing. The second sound entry hole has a second axial direction pointing to an outside of the second housing. An angle between an orthographic projection of the first axial direction on the symmetry plane and an orthographic projection of the second axial direction on the symmetry plane is greater than or equal to 115 degrees.

In some embodiments, the earphone further comprises a switching device. The two first microphones are connected to a same audio port of the processing circuit via the switching device. The processing circuit controls one first microphone of the two first microphones that is relatively higher in the gravity direction to be connected to the processing circuit according to the detection result of the detection element to cause the one first microphone to be in the operating state, and disconnects a connection between other one first microphone of the two first microphones that is relatively lower in the gravity direction and the processing circuit to cause the another one first microphone to be in the non-operating state.

The beneficial effect of the present disclosure is: by providing two first microphones, so that in the wearing state, regardless of whether the earphone is worn on the left ear or the right ear, the one first microphone of the two first microphones that is relatively higher in the gravity direction is in the operating state, which is conducive to improving the difference between the first sound collected by the first microphone and the second sound collected by the second microphone, is conducive to improving the noise reduction processing effect of the earphone, ensuring the sound pickup effect of the earphone while realizing the left-right ear interchange function of the earphone, and improving the user experience.

### BRIEF DESCRIPTION OF THE DRAWINGS

FIG. 1 is a schematic diagram of a wearing state of an earphone worn on a human ear according to some embodiments of the present disclosure;

FIG. 2 is a front-view schematic diagram of a structure of the earphone shown in FIG. 1;

FIG. 3 is a perspective schematic diagram of a structure of the earphone shown in FIG. 1;

FIG. 4 is a top-view schematic diagram of a structure of the earphone shown in FIG. 1;

FIG. 5 is another top-view schematic diagram of a structure of the earphone shown in FIG. 1;

FIG. 6 is a cross-sectional schematic diagram of a structure of the earphone shown in FIG. 5 along section line V-V;

FIG. 7 is an enlarged schematic diagram of a partial area Z of the earphone shown in FIG. 4;

FIG. 8 is another top-view schematic diagram of a structure of the earphone shown in FIG. 1;

FIG. 9 is a contour schematic diagram of a cross-section corresponding to the section line V-V shown in FIG. 6;

FIG. 10 is another top-view schematic diagram of a structure of the earphone shown in FIG. 1;

FIG. 11 is another top-view schematic diagram of a structure of the earphone shown in FIG. 1;

FIG. 12 is another perspective schematic diagram of a structure of the earphone shown in FIG. 1;

FIG. 13 is a schematic block diagram of a circuit structure of the earphone shown in FIG. 1;

FIG. 14 is a front-view schematic diagram of a structure of a sound-producing portion shown in FIG. 2;

FIG. 15 is a cross-sectional schematic diagram of a sound-producing portion shown in FIG. 11 along section line A-A; and

FIG. 16 is another cross-sectional schematic diagram of the earphone shown in FIG. 5 along section line V-V.

### DETAILED DESCRIPTION

The present disclosure will be further described in detail below through specific embodiments in conjunction with the accompanying drawings. Similar elements in different embodiments adopt associated similar element reference numerals. In the following embodiments, many details are described to enable a better understanding of the present disclosure. However, those skilled in the art can readily recognize that some of these features may be omitted under different circumstances or may be replaced by other elements, materials, or methods. In some cases, some operations related to the present disclosure are not shown or described in the present disclosure to avoid obscuring the core part of the present disclosure with excessive description. For those skilled in the art, it is not necessary to describe these related operations in detail, as they can fully understand the related operations based on the descriptions in the present disclosure and general technical knowledge in the field.

In addition, the features, operations, or characteristics described in the present disclosure can be combined in any suitable manner to form various embodiments. At the same time, the steps or actions in the method description can also be sequentially exchanged or adjusted in a manner obvious to those skilled in the art. Therefore, the various sequences in the present disclosure and drawings are only for clearly describing a certain embodiment and do not mean that they are mandatory sequences, unless it is stated that a certain sequence must be followed.

The serial numbers assigned to components in this document, such as “first”, “second”, etc., are only used to distinguish the described objects and have no sequential or technical meaning. The terms “connected” and “coupled” in the present disclosure, unless otherwise specified, include both direct and indirect connection (coupling).

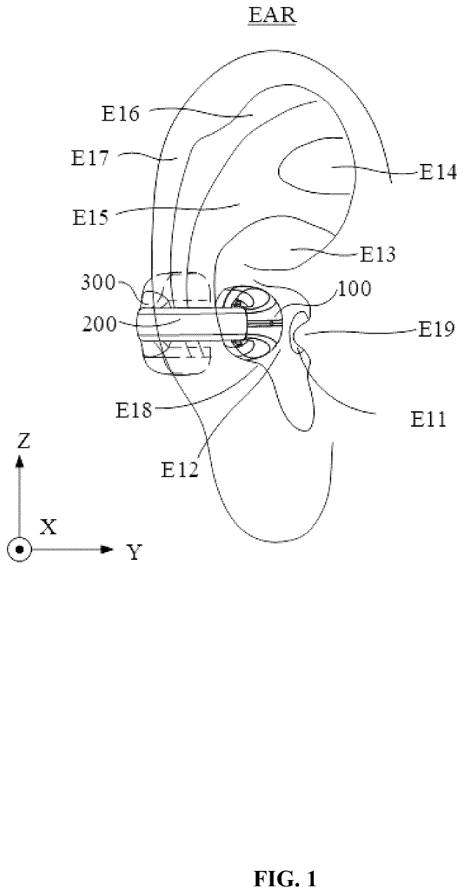

As shown in FIG. 1, an ear EAR of a user may include physiological parts such as an external auditory canal E11, a cavum conchae E12, a cymba conchae E13, a triangular fossa E14, an antihelix E15, a scaphoid fossa E16, an auricle E17, and an antitragus E18. Although the external auditory canal E11 has a certain depth and extends to an eardrum of the ear EAR, for ease of description and in conjunction with FIG. 1, in the present disclosure, unless otherwise specified, the external auditory canal E11 specifically refers to its entrance away from the eardrum (i.e., the ear hole). Furthermore, the physiological parts such as the cavum conchae E12, the cymba conchae E13, and the triangular fossa E14 have a certain volume and depth; and the cavum conchae E12 is directly connected to the external auditory canal E11, meaning that the aforementioned ear hole may simply be regarded as being located at a bottom of the cavum conchae E12.

Furthermore, around the external auditory canal of the ear EAR, there is also a tragus E19. Compared to the physiological parts such as the cavum conchae E12, the cymba conchae E13, and the triangular fossa E14, which have a certain depth and volume in three-dimensional space, meaning these physiological parts are recessed towards a rear side of the ear EAR along a direction closer to the user's head, the tragus E19 protrudes towards a front side of the ear EAR along a direction away from the user's head. Here, “the front side of the ear EAR” is a concept relative to “the rear side of the ear EAR”. The former refers to a side of the ear EAR away from the head, for example, as shown in FIG. 1, and the latter refers to a side of the ear EAR facing the head. Both are relative to the user's ear EAR.

Furthermore, different users may have individual differences, leading to variations in the shape, size, and other dimensions of the ear EAR. For ease of description and to reduce (or even eliminate) individual differences among users, a simulator containing a head and its (left and right) ears EAR may be manufactured based on standards ANSI:S3.36, S3.25, and IEC:603187, such as the GRAS 45BC KEMAR. Therefore, descriptions such as “the user wears an earphone”, “the earphone is in a wearing state”, and “in the wearing state” may refer to the earphone described in the present disclosure being worn on the ear EAR of the simulator. Of course, precisely because different users have individual differences, there may be some discrepancies when the earphone is worn by different users compared to when it is worn on the ear EAR of the simulator, but such discrepancies should be tolerable.

It should be noted that in fields such as medicine and anatomy, three basic planes of the human body are defined: a sagittal plane, a coronal plane, and a horizontal plane, as well as three basic axes: a sagittal axis, a coronal axis, and a vertical axis. The sagittal plane is a plane perpendicular to the ground made along an anteroposterior direction of the body, dividing the body into left and right parts; the coronal plane is a plane perpendicular to the ground made along a left-right direction of the body, dividing the body into front and back parts; the horizontal plane is a plane parallel to the ground made along a superior-inferior direction of the body, dividing the body into upper and lower parts. Correspondingly, the sagittal axis is an axis along the anteroposterior direction of the body and perpendicular to the coronal plane; the coronal axis is an axis along the left-right direction of the body and perpendicular to the sagittal plane; the vertical axis is an axis along the superior-inferior direction of the body and perpendicular to the horizontal plane. Furthermore, the “front side of the ear EAR” described in the present disclosure is a concept relative to the “rear side of the ear EAR”. The former refers to a side of the ear EAR away from the head, and the latter refers to a side of the ear EAR facing the head. Both are relative to the user's ear EAR. By observing the ear EAR of the simulator along the direction of the human coronal axis, a schematic diagram of the front outline of the ear EAR as shown in FIG. 1 may be obtained. Based on this, and in conjunction with FIG. 1, the three directions X, Y, and Z may be simply regarded as the human coronal axis, the human sagittal axis, and the human vertical axis, respectively; the three planes XY, XZ, and YZ may be simply regarded as the human horizontal plane, the human coronal plane, and the human sagittal plane, respectively.

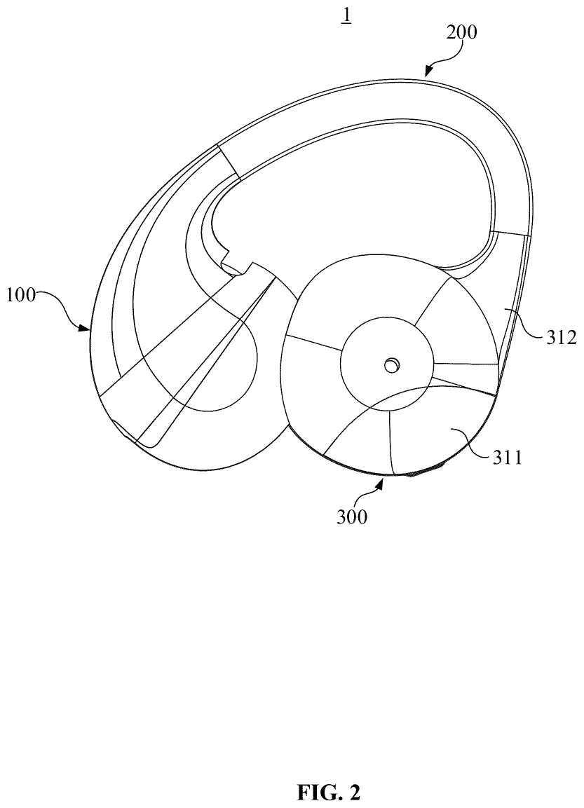

An embodiment of the present disclosure describes at least one exemplary structure of an earphone 1. As shown in FIG. 1, FIG. 1 shows a state of the earphone 1 worn on the user's ear EAR. The earphone 1 may be an ear-clip earphone. As shown in FIGS. 1 to 3, the earphone 1 includes a sound-producing portion 100 for inserting into the cavum conchae E12 of the user (wearer), an abutting portion 300 for abutting the back of the user's ear, and an ear hook 200 connected to the sound-producing portion 100 and the abutting portion 300. In the wearing state, the ear hook 200 may go around the user's auricle E17, the sound-producing portion 100 and the abutting portion 300 form a clamping state on both sides of the wearer's auricle E17, and the sound-producing portion 100 is located within the cavum conchae E12. The sound-producing portion 100 is a sound playback device that converts electrical signals into sound signals and plays the sound signals to the wearer. The abutting portion 300 forms the clamping state with the sound-producing portion 100 to clamp and wear the entire earphone 1 on the wearer's ear EAR. In some embodiments, the abutting portion 300 may contain components such as a battery and a circuit board. Of course, the abutting portion 300 may also be used without a battery, and the battery may be installed in the sound-producing portion 100.

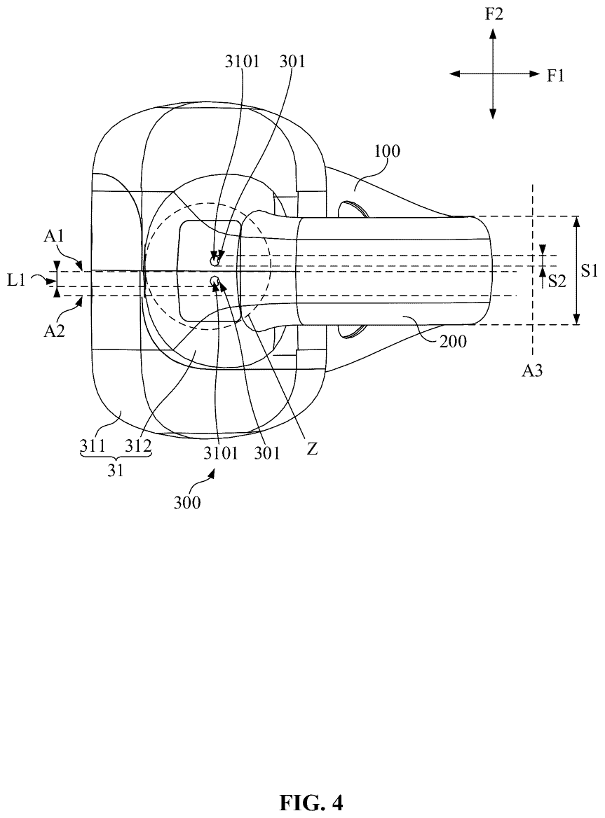

In some embodiments, as shown in FIG. 4, the ear hook 200 has a symmetry plane A1 arranged along a length direction F1 of the ear hook 200. Specifically, the symmetry plane A1 of the ear hook 200 is set along the length direction F1 of the ear hook 200, and the parts of the ear hook 200 on both sides of the symmetry plane A1 have minimal difference or are consistent. That is, if the ear hook 200 is regularly symmetrical, then the parts of the ear hook 200 on both sides of the symmetry plane A1 are consistent. If the ear hook 200 is not strictly symmetrical, then the difference between the parts of the ear hook 200 on both sides of the symmetry plane A1 should be the smallest among various division manners. For example, a projection of the ear hook 200 may be observed on a plane perpendicular to the symmetry plane A1 to distinguish the magnitude of the difference.

Optionally, as shown in FIGS. 4, 5, and 6, the abutting portion 300 includes a first housing 31 and a first microphone 32 disposed within the first housing 31. The first microphone 32 collects the first sound through a first sound entry hole 3101 on the first housing 31. The sound-producing portion 100 includes a second housing 11 and a second microphone 12 disposed within the second housing 11. The second microphone 12 collects a second sound via a second sound entry hole 1101 on the second housing 11. The earphone 1 further includes a processing circuit 400 that performs noise reduction processing based on the first sound and the second sound. The earphone 1 also has a first reference plane A2 that is located below the symmetry plane A1 and parallel to the symmetry plane A1 in the wearing state. The distance from the first reference plane A2 to the symmetry plane A1 is less than or equal to 5 mm, for example, the distance may be 1 mm, 2 mm, 2.5 mm, 3 mm, 3.5 mm, 4 mm, 4.5 mm, and of course, the distance may also be other values. The first sound entry hole 3101 has a sound entry end 301 located on an outer wall surface of the first housing 31. External sound is guided into the first sound entry hole 3101 from the sound entry end 301 and transmitted to the first microphone 32 via the first sound entry hole 3101. The entire sound entry end 301 of the first sound entry hole 3101 is located on the side of the first reference plane A2 facing the symmetry plane A1.

The processing circuit 400 may perform noise reduction processing based on the first sound and the second sound. For example, by arranging the first sound entry hole 3101 and the second sound entry hole 1101 at different positions, the sounds imported by the first sound entry hole 3101 and the second sound entry hole 1101 may have certain differences, so that the sounds collected by the first microphone 32 and the second microphone 12 have different signal amplitudes in the main sound reception frequency band. The main sound reception frequency band may be, such as a human voice reception frequency band. Thus, the processing circuit 400 may use the first sound and the second sound to identify and eliminate noise.

By arranging the entire sound entry end 301 of the first sound entry hole 3101 to be located on the side of the first reference plane A2 facing the symmetry plane A1, the position of the sound entry end 301 of the first sound entry hole 3101 is restricted. On one hand, this enables the sound entry end 301 of the first sound entry hole 3101 to be largely shielded by the user's auricle E17 in the wearing state, while the second sound entry hole 1101 provided on the sound-producing portion 100 is closer to the user's mouth and is not shielded, thereby increasing the degree of difference between the sounds introduced by the first sound entry hole 3101 and the sound introduced by the second sound entry hole 1101, i.e., increasing the difference between the first sound collected by the first microphone 32 and the second sound collected by the second microphone 12. This is conducive to improving the noise reduction effect of the processing circuit 400 using the first sound and the second sound for noise reduction processing. On the other hand, it also ensures that the connection line between the first sound entry hole 3101 and the second sound entry hole 1101 has good directivity towards the mouth, which is beneficial for improving the sound pickup effect of the earphone 1 and enhancing the user experience.

Optionally, as shown in FIG. 4, the sound entry end 301 of the first sound entry hole 3101 is at least partially located on the side of the symmetry plane A1 facing the first reference plane A2. A maximum straight-line distance L1 from a hole edge of the sound entry end 301 of the first sound entry hole 3101 located on the side of the symmetry plane A1 facing the first reference plane A2 to the symmetry plane A1 is less than or equal to 4 mm, for example, the maximum straight-line distance L1 may be 0.5 mm, 1 mm, 2 mm, 2.5 mm, 3 mm, 3.5 mm, and of course, the maximum straight-line distance L1 may also be other values.

Referring to FIG. 1, since the user's auricle E17 is generally convex and arc-shaped, and the convexity of the upper part along the human vertical axis is greater than that of the lower part, therefore, in the wearing state, the higher the sound entry end 301 of the first sound entry hole 3101 is located, the greater the degree of shielding of the first sound entry hole 3101 by the user's convex auricle E17, and the greater the difference between the first sound collected by the first microphone 32 and the second sound collected by the second microphone 12, which is more conducive to improving the noise reduction effect.

By setting the maximum straight-line distance L1 from the hole edge of the sound entry end 301 of the first sound entry hole 3101 located on the side of the symmetry plane A1 facing the first reference plane A2 to the symmetry plane A1 to be less than or equal to 4 mm, in the wearing state, the user's convex auricle E17 can better shield the first sound entry hole 3101. The connection line between the first sound entry hole 3101 and the second sound entry hole 1101 has good directivity towards the mouth, thereby helping to increase the difference between the first sound collected by the first microphone 32 and the second sound collected by the second microphone 12.

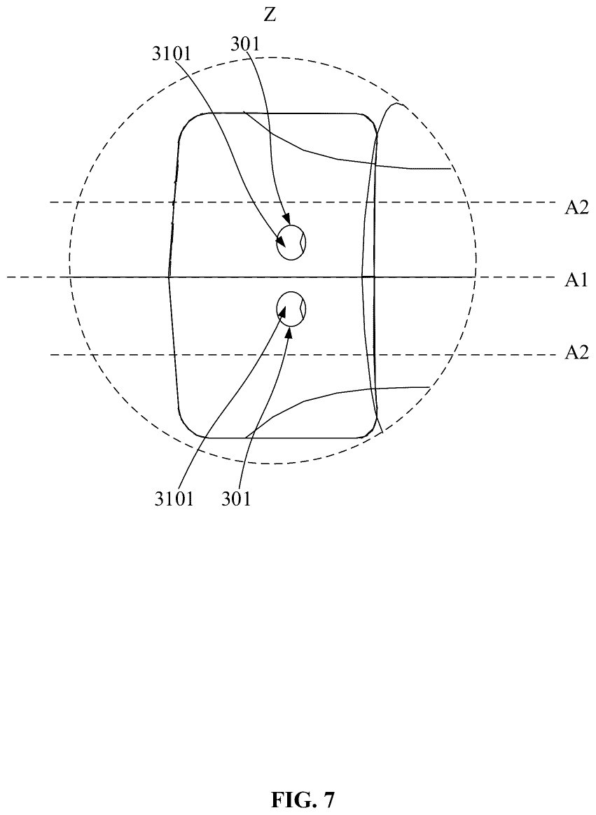

Optionally, as shown in FIG. 7, the earphone 1 is configured to support a left ear wearing state and a right ear wearing state, i.e., the earphone 1 may be worn on the user's left ear or on the user's right ear. A count of the first reference planes A2 is two, and they are symmetrically arranged on both sides of the symmetry plane A1. One of the first reference planes A2 is located below the symmetry plane A1 when the earphone 1 is in the left ear wearing state, and the other first reference plane A2 is located below the symmetry plane A1 when the earphone 1 is in the right ear wearing state. The entire sound entry end 301 of the first sound entry hole 3101 is located between the two first reference planes A2.

Configuring the earphone 1 to be not limited to being worn only on the left ear or only on the right ear, but to be wearable on both the left ear and the right ear, means that when the user switches the earphone 1 from the left ear wearing state to the right ear wearing state, or from the right ear wearing state to the left ear wearing state, the state of the earphone 1 relative to the ear EAR remains unchanged, i.e., the orientation of a sound output hole 1102 and a pressure relief hole 1103 on the earphone 1 relative to the external auditory canal E11 remains unchanged, and the appearance when worn on the left or right ear is indistinguishable. Furthermore, the earphone 1 will automatically identify the worn ear EAR and adopt a matching control logic to change the functions of the earphone 1 when worn on different ears, such as left/right channel selection or touch control function switching. By arranging the entire sound entry end 301 of the first sound entry hole 3101 to be located between the two first reference planes A2, regardless of whether the earphone 1 is worn on the left ear or the right ear, the sound entry end 301 of the first sound entry hole 3101 can be largely shielded by the user's auricle E17. The connection line between the first sound entry hole 3101 and the second sound entry hole 1101 maintains good directivity towards the mouth, enabling the earphone 1 to achieve good noise reduction effects in both the left ear wearing state and the right ear wearing state, which is beneficial for improving the sound pickup effect of the earphone 1, enhancing the consistency of the earphone 1 in the left ear wearing state and the right ear wearing state, and improving the user experience.

Optionally, as shown in FIG. 7, a count of the first sound entry holes 3101 is two. The sound entry ends 301 of the two first sound entry holes 3101 are arranged on both sides of the symmetry plane A1, and the first sound entry holes 3101 are entirely located between the two first reference planes A2. When the earphone 1 is worn on the left ear or the right ear, the relative positions between the first sound entry holes 3101 and the ear EAR are similar, or even substantially the same, so that when the earphone 1 is swapped between left and right ears, relatively similar noise reduction effects can be achieved, which is beneficial for improving the sound pickup effect of the earphone 1 and enhancing the user experience.

Optionally, as shown in FIG. 7, the sound entry ends 301 of the two first sound entry holes 3101 are symmetrically arranged relative to the symmetry plane A1, so that the earphone 1 can achieve the same noise reduction effect when swapped between left and right ears. In addition, the symmetrical arrangement is also conducive to improving the aesthetic appearance.

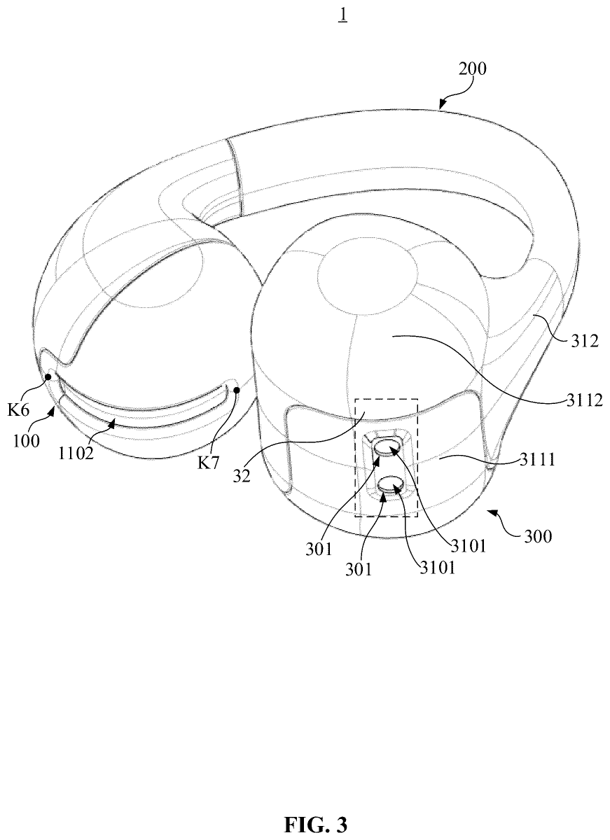

Optionally, as shown in FIG. 3 or FIG. 4, the count of the first microphone 32 is one. The first microphone 32 collects the first sound through the two first sound entry holes 3101. The sound entry ends 301 of the two first sound entry holes 3101 are spaced apart from each other, and the two first sound entry holes 3101 are communicated with each other. The two communicated first sound entry holes 3101 are beneficial for maintaining air pressure balance. Specifically, airflow may flow in from one of the first sound entry holes 3101 and out through the other first sound entry hole 3101, thereby helping to reduce a wind noise in the first sound collected by the first microphone 32. The structure is simple and can save installation space.

In some embodiments, the count of the first sound entry hole 3101 may also be one, and the symmetry plane A1 passes through the first sound entry hole 3101. In this way, the earphone 1 can achieve the same noise reduction effect whether worn on the left ear or the right ear. In this case, whether worn on the left ear or the right ear, the sound entry end 301 of the first sound entry hole 3101 can be largely shielded by the user's auricle E17. The connection line between the first sound entry hole 3101 and the second sound entry hole 1101 has good directivity towards the mouth, which is conducive to improving the noise reduction effect, improving the sound pickup effect of the earphone 1, and enhancing the user experience.

Furthermore, in some embodiments, the count of the first microphones 32 may also be two, each first microphone 32 corresponding to one first sound entry hole 3101. The present disclosure does not limit this, and those skilled in the art may make choices according to actual needs.

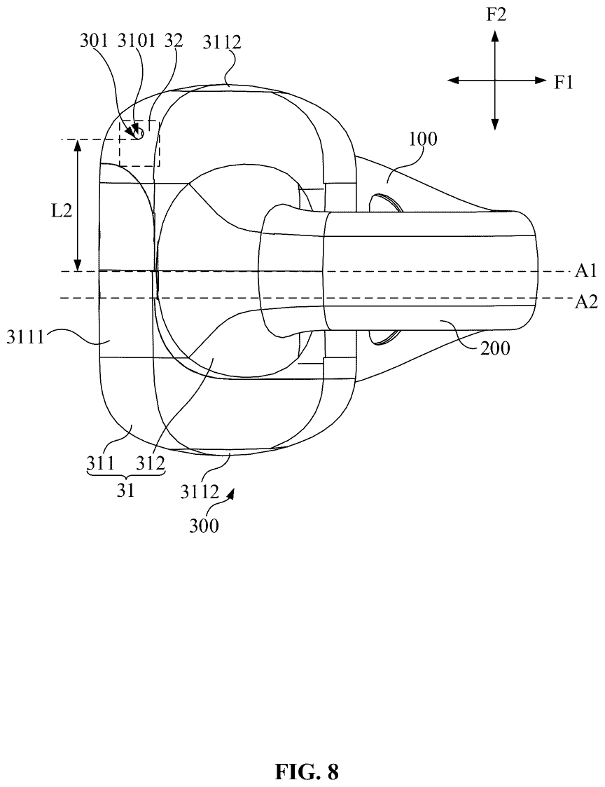

Optionally, as shown in FIG. 8, the earphone 1 may be configured to support only the left ear wearing state or only the right ear wearing state. The entire sound entry end 301 of the first sound entry hole 3101 is located on the side of the symmetry plane A1 away from the first reference plane A2, to enhance the shielding effect of the user's auricle E17 on the sound entry end 301 of the first sound entry hole 3101 in the wearing state, and to make the connection line between the first sound entry hole 3101 and the second sound entry hole 1101 better point towards the mouth. This is conducive to increasing the degree of difference between the sound introduced by the first sound entry hole 3101 and the sound introduced by the second sound entry hole 1101, thereby improving the noise reduction processing effect of the earphone 1.

Optionally, as shown in FIG. 8, a shortest straight-line distance L2 from the hole edge of the sound entry end 301 of the first sound entry hole 3101 to the symmetry plane A1 is greater than or equal to 5 mm, for example, the shortest straight-line distance L2 may be 5.5 mm, 6 mm, 6.5 mm, 7 mm, and of course, the shortest straight-line distance L2 may also be other values. When two communicated first sound entry holes 3101 are provided, the shortest straight-line distance L2 refers to a shortest straight-line distance from the hole edge of the first sound entry hole 3101 closer to the symmetry plane A1 to the symmetry plane A1, or the smaller one of the shortest straight-line distances from the hole edges of the two first sound entry holes 3101 to the symmetry plane A1, respectively.

By setting the shortest straight-line distance L2 from the hole edge of the sound entry end 301 of the first sound entry hole 3101 to the symmetry plane A1 to be greater than or equal to 5 mm, the sound entry end 301 of the first sound entry hole 3101 is largely away from the symmetry plane A1, which is beneficial for enhancing the shielding effect of the user's auricle E17 on the sound entry end 301 of the first sound entry hole 3101 in the wearing state, and makes the connection line between the first sound entry hole 3101 and the second sound entry hole 1101 better point towards the mouth, thereby helping to improve the noise reduction processing effect of the earphone 1.

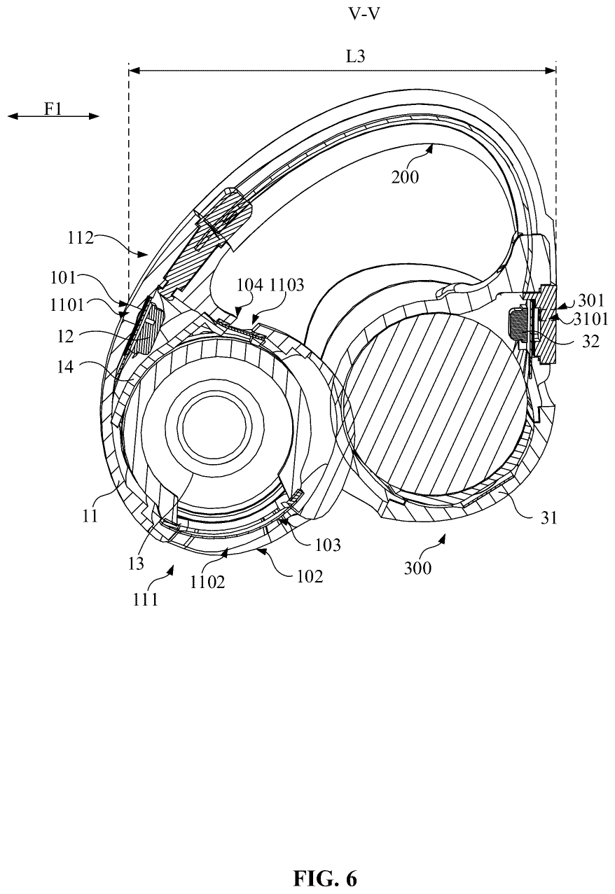

Optionally, as shown in FIG. 8, the first housing 31 includes a main body portion 311. The main body portion 311 includes a peripheral side wall 3111 and two oppositely arranged end walls 3112. The peripheral side wall 3111 is configured to contact the back side of the auricle E17. The first sound entry hole 3101 may also be arranged on the peripheral side wall 3111 and located on a side of the peripheral side wall 3111 facing away from the sound-producing portion 100. In some embodiments, the first sound entry hole 3101 may be arranged on the end wall 3112. The present disclosure does not limit this, and those skilled in the art may make choices according to actual needs. Optionally, as shown in FIG. 6, the second sound entry hole 1101 has a sound entry end 101 located on an outer wall surface of the second housing 11. A shortest straight-line distance L3 between a hole edge of the sound entry end 101 of the second sound entry hole 1101 and the hole edge of the sound entry end 301 of the first sound entry hole 3101 is greater than or equal to 15 mm, for example, the shortest straight-line distance L3 may be 15 mm, 18 mm, 20 mm, 30 mm, and of course, the shortest straight-line distance L3 may also be other values.

By setting the shortest straight-line distance L3 between the hole edge of the sound entry end 101 of the second sound entry hole 1101 and the hole edge of the sound entry end 301 of the first sound entry hole 3101 to be greater than or equal to 15 mm, the difference between the first sound collected by the first microphone 32 and the second sound collected by the second microphone 12 is increased, which is conducive to improving the noise reduction effect of the processing circuit 400 using the first sound and the second sound for noise reduction processing, beneficial for improving the sound pickup effect of the earphone 1, and beneficial for enhancing the user experience.

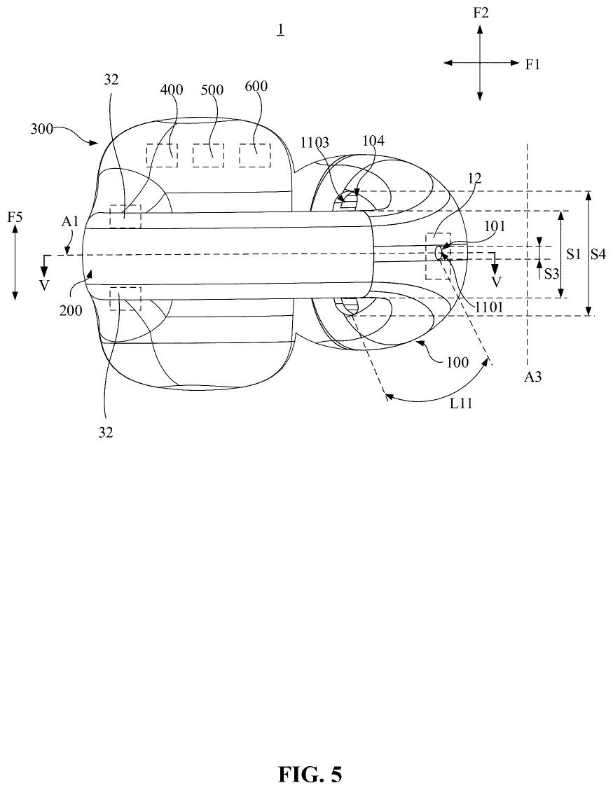

Optionally, as shown in FIG. 4 and FIG. 5, along the width direction F2 of the ear hook 200, the sound entry end 301 of the first sound entry hole 3101 and the sound entry end 101 of the second sound entry hole 1101 are respectively arranged to at least partially overlap with the ear hook 200.

Specifically, the symmetry plane A1 is perpendicular to the width direction F2 of the ear hook 200. Taking a straight line perpendicular to the symmetry plane A1 and parallel to the width direction F2 of the ear hook 200 as a reference line A3, when the ear hook 200 is projected onto the reference line A3 along the symmetry plane A1, it has a first projection width S1. When the sound entry end 301 of the first sound entry hole 3101 is projected onto the reference line A3 along the symmetry plane A1, it has a second projection width S2. When the sound entry end 101 of the second sound entry hole 1101 is projected onto the reference line A3 along the symmetry plane A1, it has a third projection width S3. The second projection width S2 and the third projection width S3 at least partially overlap with the first projection width S1, respectively, so that the ear hook 200 may form a barrier between the sound entry end 301 of the first sound entry hole 3101 and the sound entry end 101 of the second sound entry hole 1101, thereby increasing the difference between the first sound collected by the first microphone 32 and the second sound collected by the second microphone 12, which is beneficial for improving the noise reduction processing effect of the earphone 1.

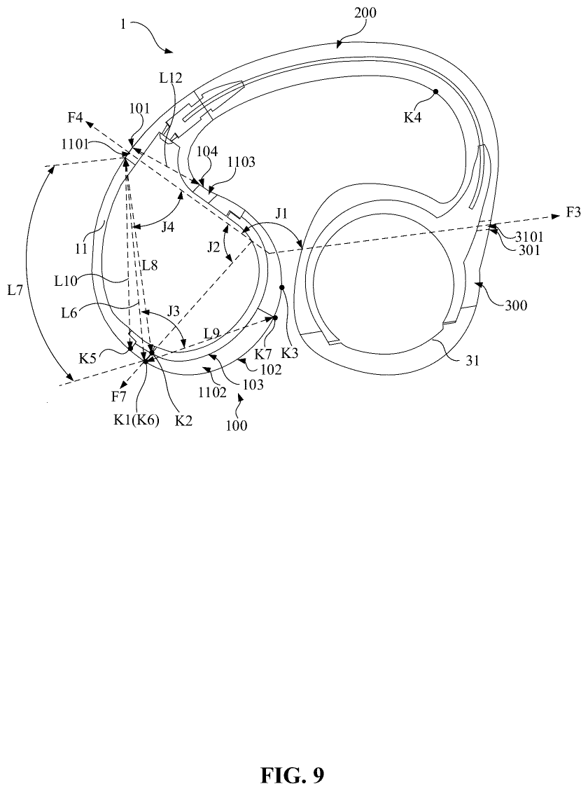

Optionally, as shown in FIG. 9, the first sound entry hole 3101 has a first axial direction F3 pointing to the outside of the first housing 31, and the second sound entry hole 1101 has a second axial direction F4 pointing to the outside of the second housing 11. An angle J1 between an orthographic projection of the first axial direction F3 on the symmetry plane A1 and an orthographic projection of the second axial direction F4 on the symmetry plane A1 is greater than or equal to 115 degrees, for example, the angle J1 may be 115 degrees, 120 degrees, 125 degrees, 130 degrees, and of course, the angle J1 may also be other values.

The following manner may specifically determine the first axial direction F3 of the first sound entry hole 3101: when a reference cylinder matching the size of the first sound entry hole 3101 is inserted through the first sound entry hole 3101, the axial direction of the reference cylinder is the first axial direction F3 of the first sound entry hole 3101. It should be noted that “matching the size” described here means that the reference cylinder can be inserted through the first sound entry hole 3101 and is unlikely to fall out.

The manner for determining the second axial direction F4 of the second sound entry hole 1101 refers to the determination of the first axial direction F3 of the first sound entry hole 3101, and will not be repeated here.

By setting the angle J1 between the orthographic projection of the first axial direction F3 on the symmetry plane A1 and the orthographic projection of the second axial direction F4 on the symmetry plane A1 to be greater than or equal to 115 degrees, the orientations of the first sound entry hole 3101 and the second sound entry hole 1101 have a certain difference, so the sounds introduced by them also have a certain difference, further increasing the difference between the first sound collected by the first microphone 32 and the second sound collected by the second microphone 12, which is beneficial for improving the noise reduction processing effect of the earphone 1.

Optionally, as shown in FIG. 4 and FIG. 8, the first housing 31 includes the main body portion 311 and a transition portion 312. The transition portion 312 is arranged on the outer peripheral surface of the main body portion 311 and connected to the ear hook 200. The transition portion 312 is tapered in a direction away from the main body portion 311, so that the ear hook 200 is smoothly connected to the outer surface of the main body portion 311. The first microphone 32 is arranged inside the transition portion 312, and the first sound entry hole 3101 is placed on the transition portion 312, to fully utilize the space of the transition portion 312, which is beneficial for improving the space utilization rate of the earphone 1 and making the structure of the earphone 1 more compact.

Optionally, the processing circuit 400 is further configured to perform wind noise detection based on at least one of the first sound or the second sound, and when it is detected that wind noise is greater than or equal to a preset threshold, the processing circuit 400 controls the first microphone 32 to be in an operating state and controls the second microphone 12 to be in a non-operating state. The operating state means that the microphone is turned on and the sound collected by the microphone may be used by the processing circuit 400. The non-operating state means that the microphone is turned off, or although the microphone is turned on, the sound collected by the microphone is not used by the processing circuit 400.

The processing circuit 400 performing wind noise detection based on the first sound and/or the second sound means that the processing circuit 400 identifies sound signal characteristics in at least one of the first sound or the second sound to judge whether there are characteristics of a wind noise signal, to detect whether there is the wind noise and the intensity of the wind noise.

Since the sound entry end 301 of the first sound entry hole 3101 is primarily shielded by the user's auricle E17 in the wearing state. In contrast, the sound entry end 101 of the second sound entry hole 1101 is not shielded, the wind noise in the sound introduced by the second sound entry hole 1101 will be greater than that introduced by the first sound entry hole 3101. Therefore, when the processing circuit 400 detects that the wind noise is greater than or equal to the preset threshold, the processing circuit 400 controls the first microphone 32 to be in the operating state and controls the second microphone 12 to be in the non-operating state, thereby avoiding the second microphone 12 collecting sound with excessive wind noise which would affect the sound pickup effect of the earphone 1, and improving the user experience.

In some implementations, as shown in FIG. 5, the abutting portion 300 includes two first microphones 32. The two first microphones 32 are configured to collect the first sound respectively. The sound-producing portion 100 includes the second microphone 12. The second microphone 12 is configured to collect the second sound. The earphone 1 further includes a detection element 500 and a processing circuit 400. The detection element 500 is configured to detect a relative positional relationship between the two first microphones 32 in the wearing state. The relative positional relationship refers to a relative up-down relationship between the two first microphones 32 in a gravity direction F5 in the wearing state. The processing circuit 400 controls one first microphone of the two first microphones 32 that is relatively higher in the gravity direction F5 to be in the operating state and controls other one that is relatively lower in the gravity direction F5 to be in the non-operating state according to a detection result of the detection element 500, and further performs noise reduction processing based on the first sound collected by the first microphone in the operating state and the second sound collected by the second microphone 12.

The operating state means that the microphone is turned on and the sound collected by the microphone may be used by the processing circuit 400. The non-operating state means that the microphone is turned off, or although the microphone is turned on, the sound collected by the microphone is not used by the processing circuit 400.

On one hand, when the earphone 1 is in the wearing state, the higher the position of the first microphone 32, the more easily the first microphone 32 is shielded by the auricle E17, making the sound pickup difference between the first microphone 32 and the second microphone 12 greater. On the other hand, when the earphone 1 is in the wearing state, the higher the position of the first microphone 32, the better the connection line between the first microphone 32 and the second microphone 12 points towards the mouth, which also makes the sound pickup difference between the first microphone 32 and the second microphone 12 greater. Therefore, by providing the two first microphones 32, so that in the wearing state, regardless of whether the earphone 1 is worn on the left ear or the right ear, the one first microphone of the two first microphones 32 that is relatively higher in the gravity direction F5 is in the operating state, which is conducive to increasing the difference between the first sound collected by the first microphone 32 and the second sound collected by the second microphone 12, beneficial for improving the noise reduction processing effect of the earphone 1, ensuring the sound pickup effect of the earphone 1 while achieving the left-right ear interchange function, and enhancing the user experience.

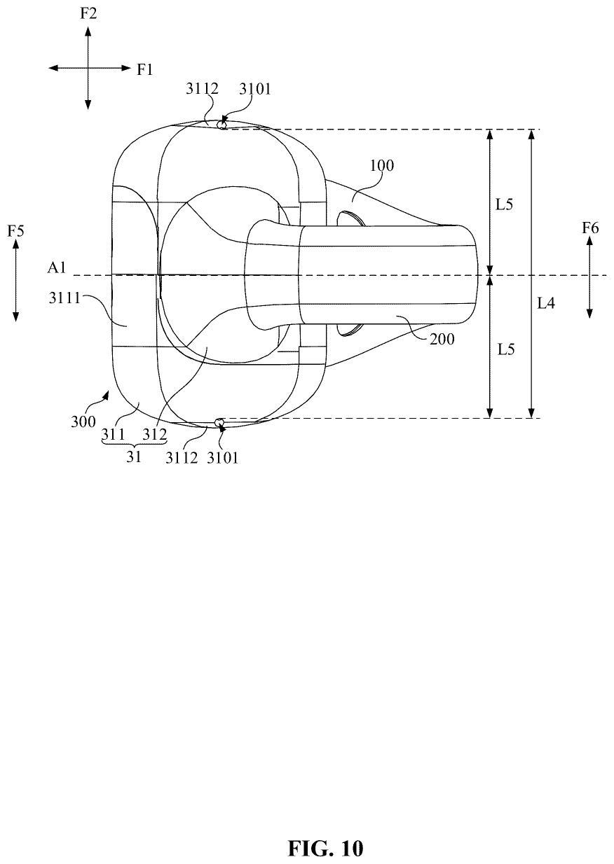

Optionally, as shown in FIG. 10, the ear hook 200 has a symmetry plane A1 arranged along the length direction F1 of the ear hook 200. The abutting portion 300 further includes a first housing 31. The first housing 31 is provided with two first sound entry holes 3101. Each first microphone 32 collects the first sound through a corresponding one of two first sound entry holes 3101. The two first sound entry holes 3101 respectively has a sound entry end 301 located on an outer wall surface of the first housing 31. The sound entry ends 301 of the two first sound entry holes 3101 are arranged on two sides of the symmetry plane A1.

By providing a corresponding first sound entry hole 3101 for each of the two first microphones 32, and arranging the sound entry ends 301 of the two first sound entry holes 3101 on both sides of the symmetry plane A1, when the first microphone 32 that is relatively higher in the gravity direction F5, i.e., the first microphone 32 located above the symmetry plane A1, is in the operating state, a sound entry end 301 of the first sound entry hole 3101 corresponding to the first microphone 32 is also located above the symmetry plane A1. In this way, regardless of whether the earphone 1 is worn on the left ear or the right ear, the user's auricle E17 can largely shield the first microphone 32 in the operating state, and make the connection line between the first microphone 32 in the operating state and the second microphone 12 better point towards the mouth, thereby increasing the difference between the first sound collected by the first microphone 32 and the second sound collected by the second microphone 12, improving the noise reduction processing effect of the earphone 1, ensuring the sound pickup effect of the earphone 1 while achieving the left-right ear interchange function, and benefiting the user experience.

Optionally, as shown in FIG. 10, the sound entry ends 301 of the two first sound entry holes 3101 are symmetrically arranged relative to the symmetry plane A1, so that during the process of swapping the earphone 1 between left and right ears, the two first sound entry holes 3101 can achieve the same sound introduction effect, thereby enabling the earphone 1 to achieve good noise reduction processing effects whether worn on the left ear or the right ear, and also helping to improve the aesthetic appearance of the earphone 1.

Optionally, as shown in FIG. 10, the first housing 31 includes the main body portion 311. The main body portion 311 includes the peripheral side wall 3111 and two oppositely arranged end walls 3112. The peripheral side wall 3111 is configured to contact the back side of the auricle E17. The two first sound entry holes 3101 are respectively arranged on the two end walls 3112 of the abutting portion 300, thereby further enhancing the shielding effect of the user's auricle E17 on the first sound entry hole 3101 corresponding to the first microphone 32 in the operating state in the wearing state, making the connection line between the first microphone 32 in the operating state and the second microphone 12 better point towards the mouth, thereby effectively increasing the difference between the first sound and the second sound, which is conducive to the processing circuit 400 achieving a good noise reduction processing effect.

Optionally, as shown in FIG. 10, in a direction F6 perpendicular to the symmetry plane A1, a shortest straight-line distance L4 between the hole edges of the sound entry ends 301 of the two first sound entry holes 3101 is greater than or equal to 10 mm, for example, the shortest straight-line distance L4 may be 11 mm, 12 mm, 13 mm, 15 mm, 18 mm, 20 mm, and of course, the shortest straight-line distance L4 may also be other values.

By setting the shortest straight-line distance L4 between the hole edges of the sound entry ends 301 of the two first sound entry holes 3101 to be greater than or equal to 10 mm, there is a certain distance between the two first sound entry holes 3101, then in the wearing state of the earphone 1, the first sound entry hole 3101 corresponding to the first microphone 32 in the operating state can be better shielded by the user's auricle E17, and the connection line between the first microphone 32 in the operating state and the second microphone 12 can better point towards the mouth, thereby helping to increase the difference between the sounds collected by the first microphone 32 and the second microphone 12, and improving the noise reduction processing effect of the earphone 1.

Optionally, as shown in FIG. 10, a shortest straight-line distance L5 from the hole edge of each of the sound entry ends 301 of the two first sound entry holes 3101 to the symmetry plane A1 is greater than or equal to 5 mm, for example, it may be 5.5 mm, 6 mm, 8 mm, 10 mm, 15 mm, and of course, it may also be other values.

So that there is a certain distance between the sound entry ends 301 of the two first sound entry holes 3101 and the symmetry plane A1. In this way, in the wearing state of the earphone 1, the first sound entry hole 3101 corresponding to the first microphone 32 in the operating state can be better shielded by the user's auricle E17, thereby helping to increase the difference between the sounds collected by the first microphone 32 and the second microphone 12, and the connection line between the first microphone 32 in the operating state and the second microphone 12 can better point towards the mouth, improving the noise reduction processing effect of the earphone 1.

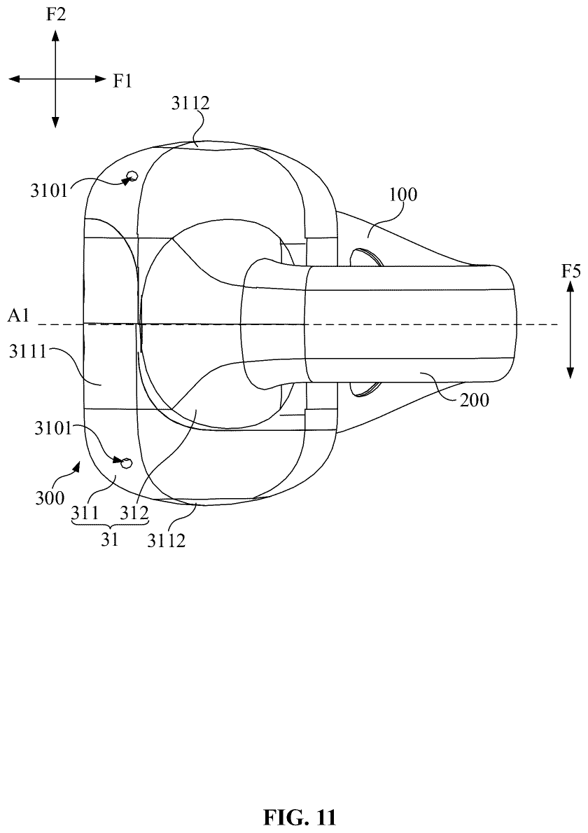

Optionally, as shown in FIG. 11, the two first sound entry holes 3101 are both arranged on the peripheral side wall 3111 of the abutting portion 300 and are located on a side of the peripheral side wall 3111 facing away from the sound-producing portion 100.

Since at least one of the two end walls 3112 of the abutting portion 300 is provided with an antenna for wireless radio frequency connection of the earphone 1 and/or a touch area for user touch operations, if the first sound entry hole 3101 is arranged on the end wall 3112, it may cause mutual interference between the antenna and/or the touch area and the first sound entry hole. Therefore, by arranging the first sound entry hole 3101 on the peripheral side wall 3111, the possibility of mutual interference between the first sound entry hole 3101 and the antenna and/or the touch area can be effectively reduced, which is beneficial for improving the stability and reliability of the earphone 1.

Optionally, the processing circuit 400 is configured to perform wind noise detection based on at least one of the first sound or the second sound. When it is detected that the wind noise is greater than or equal to the preset threshold, the processing circuit 400 further controls the one first microphone of the two first microphones 32 that collects the first sound with relatively smaller wind noise to be in the operating state, and controls the other one first microphone of the two first microphones 32 to be in the non-operating state, so that the earphone 1 can obtain the first sound with relatively less wind noise, which is conducive to achieving the good sound pickup effect for the earphone 1 and improving the user experience.

Optionally, the processing circuit 400 is further configured to perform wind noise detection based on at least one of the first sound or the second sound, and when it is detected that the wind noise is greater than or equal to the preset threshold, the processing circuit 400 further controls the other one first microphone of the two first microphones 32 that is relatively lower in the gravity direction F5 to be in the operating state and controls the second microphone 12 to be in the non-operating state.

Since the sound entry end 301 of the first sound entry hole 3101 is primarily shielded by the user's auricle E17 in the wearing state, while the sound-producing portion 100 is located in the cavum conchae E12 and is not shielded, the wind noise in the sound collected by the second microphone 12 will be greater than the sound collected by the first microphone 32. Therefore, when the wind noise is greater than or equal to the preset threshold, the processing circuit 400 can control the second microphone 12 to be in the non-operating state and one of the two first microphones 32 to be in the operating state. Furthermore, since the sound entry end 301 of the first sound entry hole 3101 corresponding to the one first microphone of the two first microphones 32 that is relatively lower in the gravity direction F5 is closer to the user's mouth, in some embodiments, only the relatively lower first microphone 32 is set to the operating state. The first sound collected by the first microphone 32 can, while maintaining relatively low wind noise, capture the user's voice as clearly and completely as possible, thereby helping to achieve the good sound pickup effect for the earphone 1 and improving the user experience.

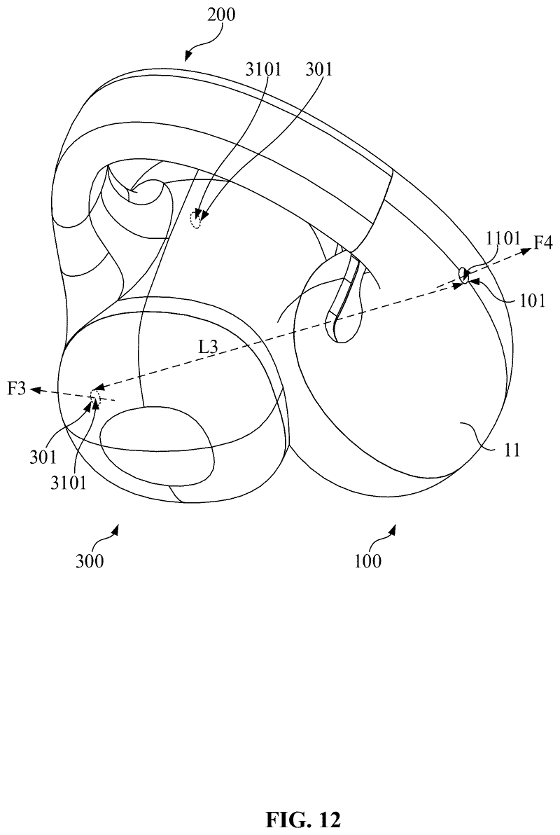

Optionally, as shown in FIG. 12, the sound-producing portion 100 includes a second housing 11. The second housing 11 is provided with a second sound entry hole 1101. The second microphone 12 collects the second sound via the second sound entry hole 1101. The second sound entry hole 1101 has a sound entry end 101 located on an outer wall surface of the second housing 11. A shortest straight-line distance L3 between a hole edge of a sound entry end 301 of a first sound entry hole 3101 and a hole edge of the sound entry end 101 of the second sound entry hole 1101 is greater than or equal to 15 mm, for example, the shortest straight-line distance L3 may be 15 mm, 17 mm, 20 mm, 25 mm, and of course, the shortest straight-line distance L3 may also be other values.

By setting the shortest straight-line distance L3 between the hole edge of the sound entry end 301 of the first sound entry hole 3101 and the hole edge of the sound entry end 101 of the second sound entry hole 1101 to be greater than or equal to 15 mm, it ensures a certain degree of difference between the sound introduced by the first sound entry hole 3101 and the sound introduced by the second sound entry hole 1101, which is conducive to the processing circuit 400 performing good noise reduction processing and improving the noise reduction processing effect of the earphone 1.

Optionally, as shown in FIG. 12, the first sound entry hole 3101 has a first axial direction F3 pointing to an outside of the first housing 31, the second sound entry hole 1101 has a second axial direction F4 pointing to an outside of the second housing 11, and an angle between an orthographic projection of the first axial direction F3 on the symmetry plane A1 and an orthographic projection of the second axial direction F4 on the symmetry plane A1 is greater than or equal to 115 degrees, for example, the angle may be 115 degrees, 120 degrees, 125 degrees, 130 degrees, and of course, the angle may also be other values.

In some embodiments, the manner for determining the first axial direction F3 of the first sound entry hole 3101 and the manner for determining the second axial direction F4 of the second sound entry hole 1101 may be the same as or similar to those in the foregoing embodiments, and will not be repeated here.

By setting the angle between the orthographic projection of the first axial direction F3 on the symmetry plane A1 and the orthographic projection of the second axial direction F4 on the symmetry plane A1 to be greater than or equal to 115 degrees, the first sound entry hole 3101 and the second sound entry hole 1101 are oriented in different directions, thereby ensuring a certain degree of difference between the sounds introduced by the first sound entry hole 3101 and the second sound entry hole 1101, effectively increasing the difference between the first sound and the second sound, and benefiting the improvement of the noise reduction processing effect of the earphone 1.

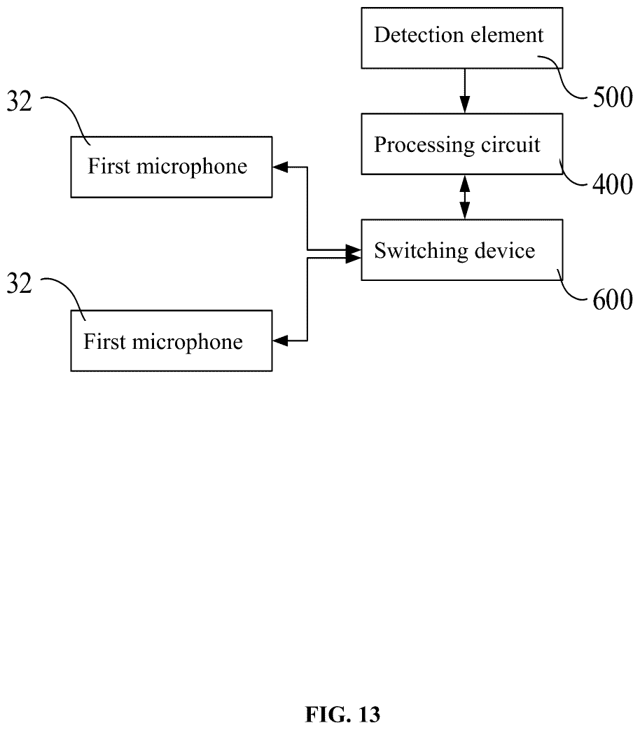

Optionally, as shown in FIG. 5 and FIG. 13, the earphone 1 further includes a switching device 600. The two first microphones 32 are connected to the same audio port of the processing circuit 400 via the switching device 600. The processing circuit 400 controls one first microphone of the two first microphones 32 that is relatively higher in the gravity direction F5 to be connected to the processing circuit 400 according to the detection result of the detection element 500 to cause the one first microphone to be in the operating state, and disconnects a connection between other one first microphone of the two first microphones 32 that is relatively lower in the gravity direction F5 and the processing circuit 400 to cause the other one first microphone to be in the non-operating state.

By providing the switching device 600, it facilitates the processing circuit 400 to perform switching control of the two first microphones 32 according to the detection result of the detection element 500, which is beneficial for improving the switching efficiency and reliability of the earphone 1.

In some embodiments, the switching of the two first microphones 32 may also be achieved solely through software, which is within the understanding of those skilled in the art and will not be repeated here.

In some embodiments, as shown in FIG. 6 and FIG. 9, the sound-producing portion 100 includes a housing and a microphone and a sound-producing assembly 13 arranged inside the housing. The housing may be the aforementioned second housing 11, and the microphone may be the aforementioned second microphone 12. The second housing 11 is provided with a sound entry hole and the sound output hole 1102. The sound entry hole may be the aforementioned second sound entry hole 1101. The second microphone 12 collects external sound via the second sound entry hole 1101, and the sound emitted by the sound-producing assembly 13 is transmitted outward through the sound output hole 1102. The second sound entry hole 1101 may be used to introduce sound to the second microphone 12, and the second microphone 12 may be used to collect the introduced sound. The second sound entry hole 1101 has the sound entry end 101 located on the outer wall surface of the second housing 11. The sound output hole 1102 has a first sound output end 102 located on the outer wall surface of the second housing 11. As shown in FIG. 9, there is a first shortest straight segment L6 between the hole edge of the sound entry end 101 of the second sound entry hole 1101 and a hole edge of the first sound output end 102. The length of the first shortest straight segment L6 is greater than or equal to 9 mm; for example, the first shortest straight segment L6 may be 9 mm, 10 mm, 12 mm, 15 mm, and of course, the first shortest straight segment L6 may also be other values.

Since sound propagation follows the inverse square law, meaning a sound intensity is inversely proportional to the square of the distance from a sound source of the sound, the farther the distance from the sound source, the smaller the sound intensity. By setting the length of the first shortest straight segment L6 to be greater than or equal to 9 mm, it effectively prevents the sound transmitted outward from the sound output hole 1102 from being introduced by the second sound entry hole 1101, thereby reducing interference to the sound collection by the second microphone 12, effectively reducing the possibility of echo during calls using the earphone 1, and benefiting the user's call experience.

Optionally, as shown in FIG. 9, along the outer wall surface of the second housing 11, there is a shortest wall surface connection line sharing endpoints with the first shortest straight segment L6 between the hole edge of the sound entry end 101 of the second sound entry hole 1101 and the hole edge of the first sound output end 102, referred to as a first shortest wall surface connection line L7. The first shortest wall surface connection line L7 is specifically the shortest arc segment formed along the contour line of the outer wall surface of the second housing 11 between the hole edge of the sound entry end 101 of the second sound entry hole 1101 and the hole edge of the first sound output end 102. The first shortest wall surface connection line L7 is arranged to protrude outward from the second housing 11. The length of the first shortest wall surface connection line L7 is greater than or equal to 13 mm, for example, the first shortest wall surface connection line L7 may be 13 mm, 15 mm, 18 mm, 20 mm, and of course, the first shortest wall surface connection line L7 may also be other values.

By setting the length of the first shortest wall surface connection line L7 to be greater than or equal to 13 mm, it helps to improve the sound isolation effect of the second housing 11 between the second sound entry hole 1101 and the sound output hole 1102, further reducing the possibility of sound transmitted outward from the sound output hole 1102 interfering with the sound collection by the second microphone 12.

Optionally, the ratio of the length of the first shortest wall surface connection line L7 to the length of the first shortest straight segment L6 is between 0.5 and 0.75. For example, the ratio may be 0.55, 0.65, or 0.7. The ratio may also be other values.

By setting the ratio of the length of the first shortest wall surface connection line L7 to the length of the first shortest straight segment L6 to be between 0.5 and 0.75, it is beneficial to improve further the sound isolation effect of the second housing 11 between the second sound entry hole 1101 and the sound output hole 1102, and beneficial to improving the sound pickup effect of the earphone 1.

Optionally, as shown in FIG. 5 and FIG. 6, the ear hook 200 has the symmetry plane A1 arranged along the length direction F1 of the ear hook 200. The symmetry plane A1 passes through the sound entry end 101 of the second sound entry hole 1101 and the first sound output end 102, respectively. In the wearing state, the sound entry end 101 of the second sound entry hole 1101 is located on a side of the second housing 11 facing away from the auricle E17, and is closer to the ear hook 200 compared to the first sound output end 102.

By arranging the sound entry end 101 of the second sound entry hole 1101 and the first sound output end 102 to intersect with the symmetry plane A1, on one hand, it makes the earphone 1 more symmetrical in appearance, and on the other hand, it allows the earphone 1 to adapt to both left and right ear wearing, which is beneficial for achieving the left-right ear interchange function and effectively improves the adaptability of the earphone 1.

Furthermore, the sound entry end 101 of the second sound entry hole 1101 is arranged to be located on the side of the second housing 11 away from the auricle E17 in the wearing state, enabling the second sound entry hole 1101 to better introduce speech from the user's mouth, thereby effectively improving the applicability of the earphone 1. In the wearing state, the sound entry end 101 of the second sound entry hole 1101 is closer to the ear hook 200 compared to the first sound output end 102, avoiding the sound-producing assembly 13, allowing the sound-producing assembly 13 to occupy a relatively large space and improving the space utilization rate within the second housing 11. In the wearing state, the first sound output end 102 of the sound output hole 1102 can be closer to the ear canal compared to the sound entry end 101 of the second sound entry hole 1101, making it easier for the sound transmitted outward from the sound-producing assembly 13 through the first sound output end 102 to enter the user's ear canal.

Optionally, as shown in FIG. 9, the second sound entry hole 1101 has an axial direction pointing to the outside of the second housing 11, which is called the second axial direction F4. The sound output hole 1102 has a second sound output end 103 located on the inner wall surface of the second housing 11, meaning the sound emitted by the sound-producing assembly 13 is transmitted to the outside of the earphone 1 sequentially through the second sound output end 103 and the first sound output end 102. There is a second shortest straight segment L8 between the hole edge of the sound entry end 101 of the second sound entry hole 1101 and the hole edge of the second sound output end 103. Taking the endpoint of the first shortest straight segment L6 on the hole edge of the first sound output end 102 as a first reference point K1, and taking the endpoint of the second shortest straight segment L8 on the hole edge of the second sound output end 103 as a second reference point K2, the sound output hole 1102 has a reference direction F7 from the second reference point K2 pointing to the first reference point K1. An angle J2 between an orthographic projection of the second axial direction F4 on the symmetry plane A1 and an orthographic projection of the reference direction F7 on the symmetry plane A1 is greater than or equal to 70 degrees, for example, the angle J2 may be 70 degrees, 75 degrees, 80 degrees, 90 degrees, and of course, the angle J2 may also be other values.

By setting the angle J2 between the orthographic projection of the second axial direction F4 on the symmetry plane A1 and the orthographic projection of the reference direction F7 on the symmetry plane A1 to be greater than or equal to 70 degrees, the second sound entry hole 1101 and the sound output hole 1102 have different orientations, thereby effectively reducing the possibility of sound transmitted from the sound output hole 1102 being introduced by the second sound entry hole 1101, effectively reducing the possibility of sound emitted by the sound-producing assembly 13 interfering with the sound collection by the second microphone 12, effectively reducing the possibility of echo during calls using the earphone 1, and benefiting the user's call experience.

Optionally, as shown in FIG. 3, the first sound output end 102 is strip-shaped. On the symmetry plane A1, the hole edge of the first sound output end 102 has a first endpoint K6 and a second endpoint K7 spaced apart along the length direction of the first sound output end 102.

The first endpoint K6 is closer to the sound entry end 101 of the second sound entry hole 1101 compared to the second endpoint K7.

By configuring the first sound output end 102 to be strip-shaped, while ensuring the area of the sound output hole 1102, when the earphone 1 is worn by the user, since the second housing 11 and the user's ear cavum conchae E12 are not completely attached, but there is a space that gradually increases from the contact area between the second housing 11 and the ear EAR towards the ear canal opening, forming a kind of wedge-shaped space, thus creating a horn structure between the sound output hole 1102 and the cavum conchae E12. Using the cavum conchae E12 as a reflective surface can create sound wave reflection enhancement. Then, the sound output from the sound output hole 1102 will be reflected and enhanced within the cavum conchae E12, utilizing the reflection effect to increase the sound pressure at the ear canal opening, so that the user can hear sound with greater intensity, effectively enhancing the user experience.

Optionally, as shown in FIG. 5 and FIG. 9, the first sound output end 102 and the sound entry end 101 of the second sound entry hole 1101 are symmetrically arranged relative to the symmetry plane A1, respectively. The first shortest straight segment L6 connects the first endpoint K6 and the point on the hole edge of the sound entry end 101 of the second sound entry hole 1101 closest to the first endpoint K6. The earphone 1 also has a third shortest straight segment L9 connecting the first endpoint K6 and the second endpoint K7. An angle J3 between the first shortest straight segment L6 and the third shortest straight segment L9 is less than or equal to 75 degrees, for example, the angle J3 may be 60 degrees, 65 degrees, 70 degrees, 75 degrees, and of course, the angle J3 may also be other values.

By setting the angle J3 between the first shortest straight segment L6 and the third shortest straight segment L9 to be less than or equal to 75 degrees, the orientation of the sound output hole 1102 relative to the second sound entry hole 1101 is further restricted, thereby effectively reducing the possibility of sound transmitted from the sound output hole 1102 being introduced by the second sound entry hole 1101, which is beneficial for improving the sound pickup effect of the earphone 1.

Optionally, the length of the third shortest straight segment L9 is greater than or equal to 7 mm; for example, the length may be 7 mm, 10 mm, 13 mm, 15 mm, and of course, the length may also be other values.

By setting the length of the third shortest straight segment L9 to be greater than or equal to 7 mm, the size of the sound output hole 1102 better matches the size and shape of the cavum conchae E12 and the ear canal, making it easier to form a horn structure that enhances sound, effectively improving the sound output effect of the earphone 1, effectively increasing the sound pressure at the ear canal, and effectively increasing the listening volume.

Optionally, as shown in FIG. 9, the second sound entry hole 1101 has an axial direction pointing to the outside of the second housing 11, which is called the second axial direction F4. An angle J4 between the second axial direction F4 and the first shortest straight segment L6 is greater than or equal to 40 degrees, for example, the angle J4 may be 40 degrees, 45 degrees, 50 degrees, 55 degrees, and of course, the angle J4 may also be other values.

By setting the angle J4 between the second axial direction F4 and the first shortest straight segment L6 to be greater than or equal to 40 degrees, the orientation of the second sound entry hole 1101 relative to the sound output hole 1102 is further restricted, thereby effectively reducing the possibility of sound transmitted from the sound output hole 1102 being introduced by the second sound entry hole 1101, which is beneficial for improving the sound pickup effect of the earphone 1.

Optionally, as shown in FIG. 9, on the symmetry plane A1, the outer wall surface of the second housing 11 has a third reference point K3 closest to the abutting portion 300. The inner contour of the ear hook 200 has a fourth reference point K4, farthest from the third reference point K3 in an area near the edge of the auricle in the wearing state. The outer wall surface of the second housing 11 further has a fifth reference point K5, farthest from the fourth reference point K4. The first sound output end 102 and the sound entry end 101 of the second sound entry hole 1101 are located on both sides of the fifth reference point K5.

In the natural state, there is no contact between the outer wall surface of the sound-producing portion 100 and the outer wall surface of the abutting portion 300. There is a position where the distance between the outer wall surface of the sound-producing portion 100 and the outer wall surface of the abutting portion 300 is the shortest. The endpoint of the line connecting the positions with the shortest distance on the outer wall surface of the second housing 11 is the third reference point K3. If, in the natural state, contact occurs between the outer wall surface of the sound-producing portion 100 and the outer wall surface of the abutting portion 300, then the length of the shortest connection between the outer wall surface of the sound-producing portion 100 and the outer wall surface of the abutting portion 300 is nearly 0. At this time, the third reference point K3 should be the midpoint of the arc formed by the contact area where the outer wall surface of the sound-producing portion 100 and the outer wall surface of the abutting portion 300 are in contact.

In the wearing state, the symmetry plane A1 is nearly parallel to the horizontal plane of the human body. Within the symmetry plane A1, the ear hook 200, the sound-producing portion 100, and the abutting portion 300 have an inner contour, which includes at least the fourth reference point K4. The fourth reference point K4 is on the inner contour and has the greatest distance from the third reference point K3. In the wearing state, the fourth reference point K4 is a reference point located on the inner contour of the ear hook 200 and corresponding to the edge of the auricle E17 (e.g., the topmost/outermost edge of the auricle E17), and the fourth reference point K4 may be an inflection point of the inner contour. For example, the inner contour as a whole is a contour line that protrudes away from the auricle E17. The curvature radius of the part of the inner contour near the edge of the auricle E17 first gradually increases, then gradually decreases, and then gradually increases again from the fourth reference point K4 towards the sound-producing portion 100 and the abutting portion 300, respectively. The fifth reference point K5 is the point on the sound-producing portion 100 that is farthest from the fourth reference point K4.

By arranging the first sound output end 102 and the sound entry end 101 of the second sound entry hole 1101 on both sides of the fifth reference point K5, the convex second housing 11 between the first sound output end 102 and the sound entry end 101 of the second sound entry hole 1101 may isolate the sound transmitted from the first sound output end 102, effectively reducing the possibility of sound transmitted from the first sound output end 102 being introduced by the second sound entry hole 1101, which is beneficial for improving the sound pickup effect of the earphone 1.

Optionally, as shown in FIG. 9, there is a fourth shortest straight segment L10 between the hole edge of the sound entry end 101 of the second sound entry hole 1101 and the fifth reference point K5. The ratio of the length of the fourth shortest straight segment L10 to the length of the first shortest straight segment L6 is between 0.71 and 0.96, for example, the ratio may be 0.75, 0.80, 0.85, 0.90, 0.95, and of course, the ratio may also be other values.

By setting the ratio of the length of the fourth shortest straight segment L10 to the length of the first shortest straight segment L6 to be between 0.71 and 0.96, the position of the sound entry end 101 of the second sound entry hole 1101 relative to the fifth reference point K5 is reasonably set, reducing the possibility of sound transmitted from the sound output hole 1102 being introduced by the second sound entry hole 1101, which is beneficial for improving the sound pickup effect of the earphone 1.

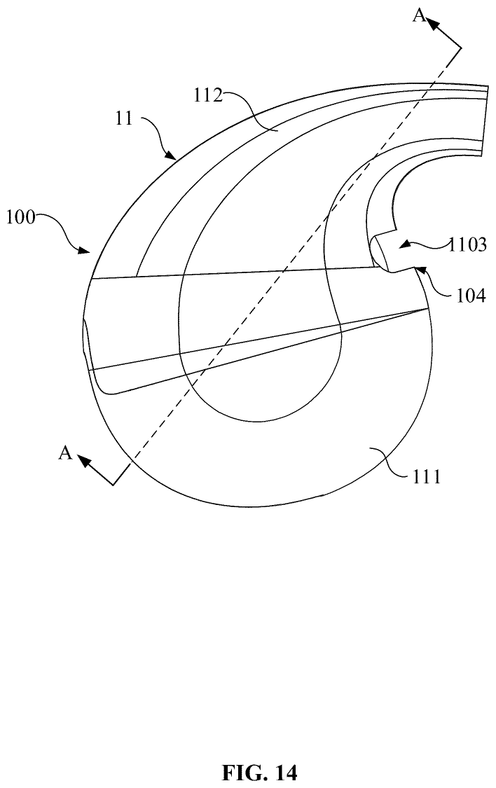

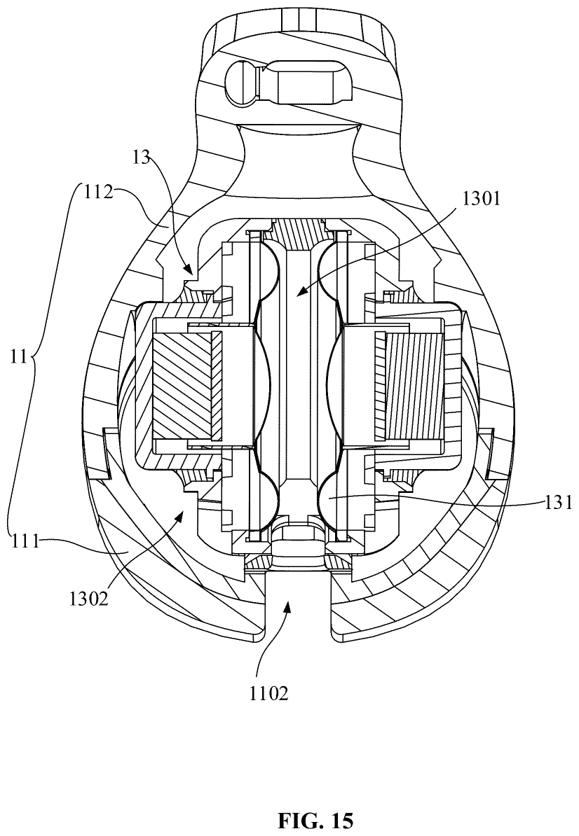

In some embodiments, as shown in FIG. 14 and FIG. 15, the sound-producing portion 100 includes a housing, and a microphone and a sound-producing assembly 13 arranged inside the housing. The housing may be the aforementioned second housing 11, and the microphone may be the aforementioned second microphone 12. The sound-producing assembly 13 has at least one diaphragm 131. The sound-producing assembly 13 cooperates with the second housing 11 to form a first acoustic cavity 1301 and a second acoustic cavity 1302 located on both sides of the diaphragm 131. The second housing 11 is provided with a sound entry hole, the sound output hole 1102, and the pressure relief hole 1103. The sound entry hole may be the second sound entry hole 1101 mentioned earlier. The second microphone 12 collects external sound via the second sound entry hole 1101. The sound in the first acoustic cavity 1301 is transmitted to the user's ear canal through the sound output hole 1102. The sound in the second acoustic cavity 1302 is transmitted to the outside of the second housing 11 through the pressure relief hole 1103. Specifically, the first acoustic cavity 1301 is a space where the diaphragm 131 vibrates, pushing air to form sound waves for the user to listen to. The second acoustic cavity 1302 is connected to the pressure relief hole 1103 and thus to the outside world, used to balance the air pressure inside the second housing 11. The second sound entry hole 1101 and the pressure relief hole 1103 are arranged adjacent to the ear hook 200, respectively. The sound output hole 1102 is arranged farther from the ear hook 200 compared to the second sound entry hole 1101 and the pressure relief hole 1103. The second sound entry hole 1101 has a sound entry end 101 located on the outer wall surface of the second housing 11. The pressure relief hole 1103 has a sound output end 104 located on the outer wall surface of the second housing 11. There is a shortest straight segment between the hole edge of the sound entry end 101 of the second sound entry hole 1101 and a hole edge of the sound output end 104 of the pressure relief hole 1103, called the fifth shortest straight segment L12. The length of the fifth shortest straight segment L12 is less than or equal to 4 mm, for example, the fifth shortest straight segment L12 may be 1 mm, 2 mm, 3 mm, 3.5 mm, and of course, the fifth shortest straight segment L12 may also be other values. The ear hook 200 is further configured to block the sound from the pressure relief hole 1103 from being transmitted to the second sound entry hole 1101.

By arranging the second sound entry hole 1101 and the pressure relief hole 1103 adjacent to the ear hook 200 respectively, setting the sound output hole 1102 relatively far from the ear hook 200, and setting the length of the fifth shortest straight segment L12 to be less than or equal to 4 mm, the sound output hole 1102 maintains a large distance from the second sound entry hole 1101 and the pressure relief hole 1103, effectively reducing the possibility of sound transmitted outward from the sound output hole 1102 interfering with the second sound entry hole 1101 and the pressure relief hole 1103. In addition, the ear hook 200 can also provide some isolation between the second sound entry hole 1101 and the pressure relief hole 1103, thereby effectively reducing interference between the pressure relief hole 1103 and the second sound entry hole 1101, effectively improving the reliability of the earphone 1, and benefiting the improvement of the sound pickup effect of the earphone 1.

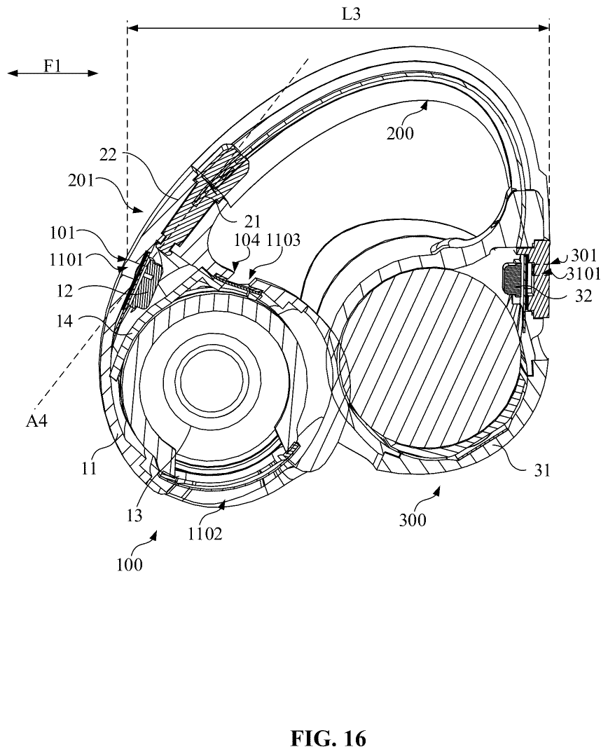

Optionally, as shown in FIG. 16, the ear hook 200 forms a connection area 201 on the second housing 11. The sound entry end 101 of the second sound entry hole 1101 and the sound output end 104 of the pressure relief hole 1103 are arranged on mutually opposite sides of the connection area 201. Or, as shown in FIG. 6, the second housing 11 includes a main body part 111 and a connection part 112. The connection part 112 connects the main body part 111 and the ear hook 200. The sound entry end 101 of the second sound entry hole 1101 and the sound output end 104 of the pressure relief hole 1103 are arranged on mutually opposite sides of the connection part 112.

By arranging the sound entry end 101 of the second sound entry hole 1101 and the sound output end 104 of the pressure relief hole 1103 on opposite sides of the connection area 201 or the connection part 112, the connection area 201 or the connection part 112 is used to isolate the second sound entry hole 1101 and the pressure relief hole 1103, effectively reducing the possibility of mutual interference between the pressure relief hole 1103 and the second sound entry hole 1101, effectively reducing the possibility of sound transmitted from the pressure relief hole 1103 being introduced by the second sound entry hole 1101, effectively reducing the possibility of sound leakage, echo, and other phenomena, and benefiting the improvement of the sound pickup effect of the earphone 1.

Optionally, as shown in FIG. 6, in the wearing state, the second sound entry hole 1101 is arranged on the side of the connection area 201 or the connection part 112 away from the auricle, and the pressure relief hole 1103 is arranged on the other side of the connection position or the connection part 112 close to the auricle.

By arranging the second sound entry hole 1101 on the side of the connection area 201 or the connection part 112 away from the auricle, it avoids the user's auricle E17 from shielding the second sound entry hole 1101 in the wearing state, thus reducing the effect on the sound introduction of the second sound entry hole 1101, which is beneficial for improving the sound pickup effect of the earphone 1.

Optionally, as shown in FIG. 6, the connection part 112 is tapered in a direction away from the main body part 111, so that the ear hook 200 is smoothly connected to the outer surface of the main body part 111, improving the aesthetic appearance of the earphone 1. The second microphone 12 is arranged inside the connection part 112, and the second sound entry hole 1101 is placed on the connection part 112, to fully utilize the space of the connection part 112, effectively improve the space utilization rate of the earphone 1, and make the structure of the earphone 1 more compact.

Optionally, as shown in FIG. 5, along the width direction F2 of the ear hook 200, the sound entry end 101 of the second sound entry hole 1101 and the sound output end 104 of the pressure relief hole 1103 are respectively arranged to at least partially overlap with the ear hook 200.

Specifically, the symmetry plane A1 is perpendicular to the width direction F2 of the ear hook 200. Taking a straight line perpendicular to the symmetry plane A1 and parallel to the width direction F2 of the ear hook 200 as a reference line A3, when the ear hook 200 is projected onto the reference line A3 along the symmetry plane A1, the ear hook 200 has the first projection width S1. When the sound entry end 101 of the second sound entry hole 1101 is projected onto the reference line A3 along the symmetry plane A1, the sound entry end 101 has the third projection width S3. When the sound output end 104 of the pressure relief hole 1103 is projected onto the reference line A3 along the symmetry plane A1, the sound output end 104 has a fourth projection width S4. The third projection width S3 and the fourth projection width S4 at least partially overlap with the first projection width S1, respectively, so that the ear hook 200 may form a barrier between the sound entry end 101 of the second sound entry hole 1101 and the sound output end 104 of the pressure relief hole 1103, thereby effectively reducing the possibility of sound transmitted from the pressure relief hole 1103 being introduced by the second sound entry hole 1101, which is beneficial for improving the sound pickup effect of the earphone 1.

Optionally, the maximum size of the overlapping portion between the sound entry end 101 of the second sound entry hole 1101 and the ear hook 200 along the width direction F2 of the ear hook 200 is equal to the maximum size of the sound entry end 101 of the second sound entry hole 1101 along the width direction F2. As shown in FIG. 5, the maximum size of the sound entry end 101 of the second sound entry hole 1101 along the width direction F2 is the size of the third projection width S3. The maximum size of the overlapping portion between the sound entry end 101 of the second sound entry hole 1101 and the ear hook 200 along the width direction F2 of the ear hook 200 is the size of the overlapping portion between the third projection width S3 and the first projection width S1. That is to say, in the width direction F2 of the ear hook 200, the sound entry end 101 of the second sound entry hole 1101 completely overlaps with the ear hook 200, meaning the entire third projection width S3 is covered by the first projection width S1.

Optionally, the ratio of the maximum size of the overlapping portion between the sound output end 104 of the pressure relief hole 1103 and the ear hook 200 along the width direction F2 of the ear hook 200 to the maximum size of the sound output end 104 of the pressure relief hole 1103 along the width direction F2 is greater than or equal to 90%. As shown in FIG. 5, the maximum size of the sound output end 104 of the pressure relief hole 1103 along the width direction F2 is the size of the fourth projection width S4. The maximum size of the overlapping portion between the sound output end 104 of the pressure relief hole 1103 and the ear hook 200 along the width direction F2 of the ear hook 200 is the size of the overlapping portion between the fourth projection width S4 and the first projection width S1. That is to say, the ratio of the size of the overlapping portion between the fourth projection width S4 and the first projection width S1 to the size of the fourth projection width S4 is greater than or equal to 90%. For example, when the first projection width S1 is completely covered by the fourth projection width S4, the ratio between the first projection width S1 and the fourth projection width S4 is greater than or equal to 90%.

In this way, the ear hook 200 can better form a barrier between the sound entry end 101 of the second sound entry hole 1101 and the sound output end 104 of the pressure relief hole 1103, which is beneficial for improving the sound pickup effect of the earphone 1.

Optionally, as shown in FIG. 5 and FIG. 16, the ear hook 200 has the symmetry plane A1 arranged along the length direction F1 of the ear hook 200. The ear hook 200 includes an elastic member 21 and an elastic coating layer 22 covering the periphery of the elastic member 21. At the end of the elastic member 21 close to the sound-producing portion 100, the ear hook 200 further has a reference plane that is tangent to the elastic member 21 and perpendicular to the symmetry plane A1. The reference plane is called the third reference plane A4. The sound entry end 101 of the second sound entry hole 1101 is arranged on one side of the third reference plane A4, and the sound output end 104 of the pressure relief hole 1103 is arranged on the other side of the third reference plane A4. The elastic member 21 may be, such as a titanium sheet. The material of the elastic coating layer 22 may include silicone, rubber, elastic resin, polyurethane, polydimethylsiloxane, PVC, and TPE, to improve wearing comfort.

By arranging the sound entry end 101 of the second sound entry hole 1101 and the sound output end 104 of the pressure relief hole 1103 on opposite sides of the third reference plane A4, respectively, the hard shell on both sides of the extended surface of the elastic member 21 is used to block further the sound entry end 101 of the second sound entry hole 1101 and the sound output end 104 of the pressure relief hole 1103, thereby further improving the isolation effect between the sound entry end 101 of the second sound entry hole 1101 and the sound output end 104 of the pressure relief hole 1103, which is beneficial for improving the sound pickup effect of the earphone 1.

Optionally, as shown in FIG. 16, in the wearing state, the second sound entry hole 1101 is arranged on the side of the third reference plane A4 away from the auricle E17, and the pressure relief hole 1103 is arranged on the other side of the third reference plane A4 close to the auricle E17, so that the second sound entry hole 1101 may introduce external sound, while the pressure relief hole 1103 has a different orientation from the second sound entry hole 1101, and the hard shell on both sides of the extended surface of the elastic member 21 isolates the second sound entry hole 1101 and the pressure relief hole 1103, effectively reducing the possibility of mutual interference between the second sound entry hole 1101 and the pressure relief hole 1103, which is beneficial for improving the sound pickup effect of the earphone 1.

Optionally, as shown in FIG. 9, on the outer wall surface of the second housing 11 and the ear hook 200, there is a shortest wall surface connection line between the hole edge of the sound entry end 101 of the second sound entry hole 1101 and the hole edge of the sound output end 104 of the pressure relief hole 1103, which is called a second shortest wall surface connection line L11. The second shortest wall surface connection line L11 is specifically the shortest arc segment formed along the contour line of the outer wall surface of the second housing 11 and the ear hook 200 between the hole edge of the sound entry end 101 of the second sound entry hole 1101 and the hole edge of the sound output end 104 of the pressure relief hole 1103.

An arc-to-chord ratio of the second shortest wall surface connection line L11 is set to be greater than or equal to 1.7, for example, the arc-to-chord ratio may be 1.7, 1.8, 1.9, 2.0, and of course, the arc-to-chord ratio may also be other values. By setting the arc-to-chord ratio of the second shortest wall surface connection line L11 to be greater than or equal to 1.7, the second housing 11 between the hole edge of the sound entry end 101 of the second sound entry hole 1101 and the hole edge of the sound output end 104 of the pressure relief hole 1103 is convex outward. The convex second housing 11 can further isolate the second sound entry hole 1101 and the pressure relief hole 1103, effectively reducing the possibility of mutual interference between the second sound entry hole 1101 and the pressure relief hole 1103, which is beneficial for improving the sound pickup effect of the earphone 1.

Optionally, as shown in FIG. 16, a partition plate 14 is arranged inside the sound-producing portion 100. The second microphone 12 is arranged on the side of the partition plate 14 close to the ear hook 200. The sound-producing assembly 13 is arranged on the side of the partition plate 14 away from the ear hook 200. By providing the partition plate 14, the second microphone 12 and the sound-producing assembly 13 are separated, effectively reducing the interference caused by the sound-producing assembly 13 to the second microphone 12, which is beneficial for improving the sound pickup effect of the earphone 1.

The above are only embodiments of the present disclosure and do not therefore limit the patent scope of the present disclosure. Any equivalent structure or equivalent process transformation made using the content of the description and drawings of the present disclosure, or direct or indirect application in other related technical fields, shall similarly be included within the patent protection scope of the present disclosure.

What is claimed is:

1. An earphone, comprising a sound-producing portion, an abutting portion, and an ear hook, wherein
the ear hook connects the sound-producing portion and the abutting portion, in a wearing state, the sound-producing portion and the abutting portion form a clamping state on two sides of an auricle, and the sound-producing portion is located in a cavum conchae;
the abutting portion includes two first microphones, the two first microphones are configured to collect a first sound respectively, the sound-producing portion includes a second microphone, the second microphone is configured to collect a second sound, and
the earphone further comprises a detection element and a processing circuit, the detection element is configured to detect a relative positional relationship between the two first microphones in the wearing state, the processing circuit controls one first microphone of the two first microphones that is relatively higher in a gravity direction to be in an operating state and controls other one first microphone of the two first microphones that is relatively lower in the gravity direction to be in a non-operating state according to a detection result of the detection element, and further performs noise reduction processing based on the first sound collected by the first microphone in the operating state and the second sound collected by the second microphone.

2. The earphone according to claim 1, wherein
the ear hook has a symmetry plane arranged along a length direction of the ear hook, and
the abutting portion further includes a first housing, the first housing is provided with two first sound entry holes, each of the two first microphones collects the first sound through a corresponding one of the two first sound entry holes, the two first sound entry holes respectively have a sound entry end located on an outer wall surface of the first housing, and the sound entry ends of the two first sound entry holes are arranged on two sides of the symmetry plane.

3. The earphone according to claim 2, wherein the sound entry ends of the two first sound entry holes are symmetrically arranged relative to the symmetry plane.

4. The earphone according to claim 2, wherein the first housing includes a main body portion, the main body portion includes a peripheral side wall and two end walls arranged opposite to each other, the peripheral side wall is configured to contact a back side of the auricle, and the two first sound entry holes are respectively arranged on the two end walls of the abutting portion.

5. The earphone according to claim 2, wherein the first housing includes a main body portion, the main body portion includes a peripheral side wall and two end walls arranged opposite to each other, the peripheral side wall is configured to contact a back side of the auricle, and the two first sound entry holes are both arranged on the peripheral side wall of the abutting portion and are located on a side of the peripheral side wall facing away from the sound-producing portion.

6. The earphone according to claim 2, wherein in a direction perpendicular to the symmetry plane, a shortest straight-line distance between hole edges of the sound entry ends of the two first sound entry holes is greater than or equal to 10 mm.

7. The earphone according to claim 2, wherein a shortest straight-line distance from a hole edge of each of the sound entry ends of the two first sound entry holes to the symmetry plane is greater than or equal to 5 mm.

8. The earphone according to claim 1, wherein the processing circuit is further configured to perform wind noise detection based on at least one of the first sound or the second sound, and when it is detected that a wind noise is greater than or equal to a preset threshold, the processing circuit further controls the other one first microphone of the two first microphones that is relatively lower in the gravity direction to be in the operating state and controls the second microphone to be in the non-operating state.

9. The earphone according to claim 2, wherein the sound-producing portion includes a second housing, the second housing is provided with a second sound entry hole, the second microphone collects the second sound via the second sound entry hole, the second sound entry hole has a sound entry end located on an outer wall surface of the second housing, and a shortest straight-line distance between a hole edge of each of the sound entry ends of the two first sound entry holes and a hole edge of the sound entry end of the second sound entry hole is greater than or equal to 15 mm.

10. The earphone according to claim 9, wherein each of the two first sound entry holes has a first axial direction pointing to an outside of the first housing, the second sound entry hole has a second axial direction pointing to an outside of the second housing, and an angle between an orthographic projection of the first axial direction on the symmetry plane and an orthographic projection of the second axial direction on the symmetry plane is greater than or equal to 115 degrees.

11. The earphone according to claim 1, wherein
the earphone further comprises a switching device, the two first microphones are connected to a same audio port of the processing circuit via the switching device, and
the processing circuit controls one first microphone of the two first microphones that is relatively higher in the gravity direction to be connected to the processing circuit according to the detection result of the detection element to cause the one first microphone to be in the operating state, and disconnects a connection between other one first microphone of the two first microphones that is relatively lower in the gravity direction and the processing circuit to cause the another one first microphone to be in the non-operating state.

12. The earphone according to claim 9, wherein
the second housing is provided with a sound output hole, the sound output hole has a first sound output end located on the outer wall surface of the second housing, there is a first shortest straight segment L6 between the hole edge of the sound entry end of the second sound entry hole and a hole edge of the first sound output end, and a length of the first shortest straight segment L6 is greater than or equal to 9 mm.

13. The earphone according to claim 12, wherein
along the outer wall surface of the second housing, there is a first shortest wall surface connection line L7 sharing endpoints with the first shortest straight segment L6 between the hole edge of the sound entry end of the second sound entry hole and the hole edge of the first sound output end, the first shortest wall surface connection line L7 is defined as a shortest arc segment formed along a contour line of the outer wall surface of the second housing between the hole edge of the sound entry end of the second sound entry hole and the hole edge of the first sound output end, the first shortest wall surface connection line L7 is arranged to protrude outward from the second housing, and a length of the first shortest wall surface connection line L7 is greater than or equal to 13 mm.

14. The earphone according to claim 13, wherein a ratio of the length of the first shortest wall surface connection line L7 to the length of the first shortest straight segment L6 is in a range of 0.5 to 0.75.

15. The earphone according to claim 9, wherein in the wearing state, the sound entry end of the second sound entry hole is located on a side of the second housing facing away from the auricle.

16. The earphone according to claim 12, wherein
the second sound entry hole has a second axial direction pointing to an outside of the second housing,
the sound output hole has a second sound output end located on an inner wall surface of the second housing, the sound emitted by a sound-producing assembly is transmitted to an outside of the earphone sequentially through the second sound output end and the first sound output end,
there is a second shortest straight segment L8 between the hole edge of the sound entry end of the second sound entry hole and the hole edge of the second sound output end,
the sound output hole has a reference direction from a second reference point K2 pointing to a first reference point K1, the first reference point K1 is defined as an endpoint of the first shortest straight segment L6 on the hole edge of the first sound output end, and the second reference point K2 is defined as an endpoint of the second shortest straight segment L8 on the hole edge of the second sound output end, and
an angle between an orthographic projection of the second axial direction on the symmetry plane and an orthographic projection of the reference direction on the symmetry plane is greater than or equal to 70 degrees.

17. The earphone according to claim 16, wherein an angle between the second axial direction and the first shortest straight segment L6 is greater than or equal to 40 degrees.

18. The earphone according to claim 12, wherein
the first sound output end and the sound entry end of the second sound entry hole are symmetrically arranged relative to the symmetry plane, respectively,
on the symmetry plane, the hole edge of the first sound output end has a first endpoint and a second endpoint spaced apart along a length direction of the first sound output end, and there is a third shortest straight segment L9 connecting the first endpoint and the second endpoint,
the first shortest straight segment L6 connects the first endpoint and a point on the hole edge of the sound entry end of the second sound entry hole closest to the first endpoint, and
an angle between the first shortest straight segment L6 and the third shortest straight segment L9 is less than or equal to 75 degrees.

19. The earphone according to claim 9, wherein
the second housing is provided with a sound output hole and a pressure relief hole,
the second sound entry hole and the pressure relief hole are arranged adjacent to the ear hook, respectively, the sound output hole is arranged farther from the ear hook compared to the second sound entry hole and the pressure relief hole,
the pressure relief hole has a sound output end located on the outer wall surface of the second housing,
there is a shortest straight segment between the hole edge of the sound entry end of the second sound entry hole and a hole edge of the sound output end of the pressure relief hole, and a length of the shortest straight segment is less than or equal to 4 mm.

20. The earphone according to claim 19, wherein
the ear hook forms a connection area on the second housing, the sound entry end of the second sound entry hole and the sound output end of the pressure relief hole are arranged on mutually opposite sides of the connection area.
